(19) United States
(12) Patent Application Publication
(10) Pub. No.: US 2021/0002753 A1
(43) Pub. Date: Jan. 7, 2021

(54) METHOD AND ARRANGEMENT FOR MACHINING A WORKPIECE

(71) Applicant: STURM MASCHINEN-& ANLAGENBAU GMBH, Salching (DE)

(72) Inventors: Wolfgang ULLRICH, Percha (DE); Sebastian PEHNELT, Altmannstein (DE)

(73) Assignee: STURM MASCHINEN-& ANLAGENBAU GMBH, Salching (DE)

(21) Appl. No.: 16/975,703

(22) PCT Filed: Sep. 10, 2019
(86) PCT No.: PCT/EP2019/074096

§ 371 Date: Aug. 25, 2020

(30) Foreign Application Priority Data
Nov. 12, 2018 (EP) 18205612.7

(51) Int. Cl. C23C 4/02; B23B 41/12; G01B 11/30; B24C 3/04; C23C 4/134

(52) U.S. Cl. CPC C23C 4/02; B23B 41/12; C23C 4/134; B24C 3/04; G01B 11/30

(57) ABSTRACT

The invention relates to a method and an arrangement for machining a workpiece with a surface, into which a groove structure with grooves and interposed ribs is introduced, wherein undesirable burrs can develop on the groove structure. According to the invention, for testing and determining the formation of burrs a measuring means is provided which emits a light to the surface of the groove structure and receives light reflected from the surface, wherein a degree of the burr formation is determined depending on the reflected light.

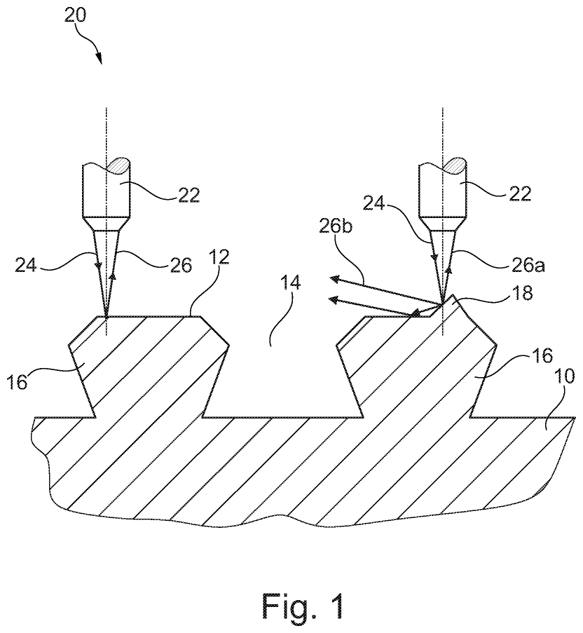

The invention relates to a method for machining a workpiece with a surface, in particular in a bore, into which a groove structure with grooves and interposed ribs is introduced, wherein undesirable burrs can develop on the groove structure, in accordance with the preamble of claim 1.

The invention further relates to an arrangement for machining a workpiece with a material removal device for introducing a groove structure with grooves and interposed ribs into a surface of the workpiece, in accordance with the preamble of claim 9.

In metal workpieces a coating of the surface may be required for specific applications. For instance, in the case of engine blocks consisting of an aluminum material a coating of the surface of the cylinder tracks may be necessary to form a functioning robust, tribological system together with the piston ring/piston. For this, it is known that a metal surface coating is applied e.g. through plasma spraying. It has proved particularly expedient to interlock the coating material with the basic material, i.e. the aluminum material, in the manner of a form fit. For this purpose, the surface to be coated is activated, i.e. roughened or provided with a defined groove structure.

Such a method can be taken, for example, from EP 3 132 893 A1 of the applicant, in which case macroscopic profile elements are introduced into the surface to be coated.

From DE 10 2013 211 324 A1 various contour shapes are known for such macroscopic profile elements for activation of the surface, such as groove structures with a rectangular profile or a dovetail profile. Before coating these are cut with a chip-removing machining tool into the surface to be coated.

During this mechanical machining process undesirable burrs can arise on the groove structure. These burrs can be points of origin for layer defects in a subsequent coating. For example, in the regions of a burr a layer can be developed such that it is insufficient or too high so that a defect arises on the workpiece. Especially in the case of the coating of cylinder tracks on engine blocks the coating is exposed to high thermal and mechanical stress so that coating errors of such type are not acceptable. During operation of the engine such a coating error can develop into a larger damage spot which, in the worst case, can lead to the failure of the entire engine.

In the manufacturing it is therefore necessary to monitor the workpieces with regard to the development of burrs on the groove structure and to determine developing burr heights. It is known that these burr heights are tested either by way of micrographs, i.e. through a destructive test, or by way of separately produced flasking plasters under a light microscope. Such a subsequent testing is laborious so that it is usually not carried out for each workpiece but, based on statistical methods, in a discontinuous manner only after a certain number of machining processes, e.g. after every 50. component. Hence, in the known tests feedback on the component quality of a production batch is obtained relatively late. It is not infrequent for a production to be interrupted until the measurement results are available for a production batch. Moreover, in such statistical methods there is the fundamental risk that unexpected deviations are not recorded or only late.

The invention is based on the object to provide a method and an arrangement for machining a workpiece by developing a groove structure, in which a development of undesirable burrs can be tested efficiently and reliably.

In accordance with the invention this object is achieved on the one hand by a method having the features of the claim 1 and on the other hand by an arrangement having the features of the claim 9. Preferred embodiments of the invention are stated in the respective dependent claims.

The method according to the invention is characterized in that for testing and determining a formation of burrs a measuring means is provided which emits a light to the surface of the groove structure and receives light reflected from the surface, wherein a degree of the burr formation is determined depending on the reflected light.

The method according to the invention can be carried out in a non-destructive and therefore efficient manner for individual workpieces or even for all of them. The invention is based on the finding that the development of burrs on a groove structure to be introduced and their height has an impact on the reflection behavior of the surface of the workpiece when irradiated with light. According to the invention a measuring means is provided which emits light to the surface of the groove structure and in turn receives light reflected therefrom, wherein the proportion of the reflected light represents a degree of the burr formation on the workpiece.

A preferred embodiment of the invention resides in the fact that by means of the measuring means the determination of the burr formation is carried out simultaneously or immediately after introduction of the groove structure. The measuring means can be located directly on the machining device or disposed immediately downstream thereof. Through this, the formation of burrs can be determined promptly, preferably on each workpiece. This offers the possibility of counteracting an incipient excessive formation of burrs. Thus, the method according to the invention can contribute to the reduction of rejects or even to an altogether zero-error manufacturing.

Basically, any type of light, in particular also a monochromatic light, can be used for the measuring means. According to a further development of the invention especially reliable measurement results are obtained due to the fact that the light is chromatic.

Furthermore, it is basically possible that the measuring means has at least one separate light source and at least one separate sensor for receiving the reflected light. According to an embodiment of the invention it is preferred that the measuring means has at least one confocal point sensor which emits and receives the light. By preference, the confocal point sensor is arranged with an objective lens perpendicularly above the surface to be examined. The confocal arrangement of the light source and the point sensor renders it possible to determine particularly reliable values concerning the reflection of the light on the surface and therefore concerning the formation of burrs.

According to an embodiment of the invention provision is made in that a reduction of a ratio between reflected light and emitted light is considered as a degree of an increase in the burr formation. It can be assumed that a surface that is substantially smooth and therefore free of burrs reflects in turn a high proportion of the emitted and preferably perpendicularly incident light back in a perpendicular manner. The more pronounced a burr formation is, i.e. the more and/or the higher the burrs are, the more light is deflected laterally by the flanks of the burrs so that this is no longer returned to the measuring means. The greater this diffusion effect is, the greater is the development of the burrs.

Basically, the groove structure can be introduced in any suitable way into the surface of the workpiece, for example also by means of a laser. According to an embodiment variant of the method pursuant to the invention a particularly efficient method for machining the workpiece resides in the fact that the groove structure is introduced with a material removing tool, in particular a cutting head or a rotary chisel. Corresponding material removing devices with cutting head or rotary chisel, also referred to as recessing tool, are sufficiently known. This chip-removing machining is particularly efficient but also involves an increased risk of burr formation.

It is a finding of the invention that not yet every burr on the introduced groove structure is detrimental to the subsequent coating. In fact, smaller burrs can even contribute to an improved interlocking effect with the applied coating. According to an embodiment variant of the invention it is preferred that on reaching a predetermined value for the reflected light the material removing tool is readjusted and/or exchanged. In this way, it is possible that in the manufacturing step of material removal and production of the groove structure timely action can be taken prior to an excessive development of burrs. Hence, the arising of undesirably large burrs can be counteracted even over a long period of time.

Moreover, according to a further development of the method pursuant to the invention it is advantageous that after introduction and testing of the groove structure a coating is applied thereto. In particular, the coating is a metal coating that is applied by spraying on metal particles, especially according to a plasma spraying method.

With regard to an arrangement for machining a workpiece the invention is characterized in that for testing and determining a formation of burrs on the groove structure a measuring means is provided which is designed to emit a light to the surface of the groove structure and receive light reflected from the surface, wherein a degree of the burr formation can be determined depending on the reflected light.

The arrangement according to the invention can be used, in particular, for carrying out the previously described method according to the invention. The advantages set out beforehand can be achieved thereby.

The measuring means provided according to the invention can itself have a computer unit available which, depending on the measurement values, determines a degree of burr formation still permissible or no longer permissible. Additionally or alternatively, the measuring means can also be connected to a central computer unit, more particularly a control unit, of the overall arrangement, by which the measurement values of the measuring means are evaluated and, according to a predetermined program structure, a decision is made as to the continuation of the method or an interruption, e.g. for exchange of the material removing tool.

Basically, the measuring means can be arranged downstream of the material removal device. For an efficient machining process provision is made according to a further development of the invention that the measuring means is arranged on the material removal device. In this way, the machining result can collectively be tested very timely and a correction, more particularly a readjustment or exchange of the tool, can in particular take place as early as in the subsequent machining process or even yet during the ongoing machining process.

According to an embodiment variant of the invention it is though especially advantageous that the groove structure is introduced into the workpiece with at least one material removing tool and in that a display is provided which, depending on a measurement result of the measuring means, displays when the at least one material removing tool is to be changed. Depending on the display e.g. an operating person could then change the material removing tool in good time. Alternatively, the arrangement can also be designed such that an automatic changing process is initiated by the control means.

Basically, the measuring means has at least one light source and at least one light-sensitive sensor. A preferred embodiment of the invention resides in the fact that the measuring means has at least one confocal point sensor which emits and receives the light. By preference, here the confocal point sensor is arranged perpendicularly above the workpiece surface to be examined. The point sensor serves both as light source for emitting the light preferably perpendicularly onto the workpiece surface and for the confocal reception of the light reflected perpendicularly from the surface. The point sensor can here be equipped with a corresponding objective lens for confocal mode of operation.

The measuring means or the at least one point sensor can be arranged on a carrier which, in particular during measurement, can be moved relative to the surface of the workpiece.

The invention is explained further hereinafter by way of a preferred exemplary embodiment illustrated schematically in the drawing.

The single FIGURE shows in a highly schematic manner an enlarged partial cross-sectional view of a workpiece 10, into a surface of which a groove structure 12 with ribs 16 that are dovetail-like in cross-section and interposed grooves 14 is introduced in a chip-removing manner. The groove structure 12 is illustrated in a greatly enlarged manner, whereas in a real workpiece 10 this can be a macroscopic groove structure with a groove depth of a few millimeters or less than one millimeter. The schematically indicated workpiece 10 can in particular be an engine block with a cylinder bore, into the bore wall of which the groove structure 12 is introduced.

By means of a measuring means 20, of which a confocal point sensor 22 is illustrated in a highly schematic manner, a light 24 is emitted substantially vertically onto the surface of the groove structure 12, in particular onto an upper side of the ribs 16. The light 24 is reflected on the surface of the groove structure 12 and can be returned as reflected light 26 into the confocal point sensor 22 of the measuring means 20. In this regard, the smoother the surface of the groove structure 12 is, the higher the proportion of reflected light 26 that is returned into the confocal point sensor 22.

As illustrated graphically on the right side of the drawing, during material removing introduction of the groove structure 12 into the surface of the workpiece 10 undesirable burrs 18 can especially arise on the ribs 16 of the groove structure 12 depending, in particular, on the state of the machining tools but also depending on the material of the respective workpiece 10.

If the point sensor 22 of the measuring means 20 is moved over the surface region with a burr 18, unlike a smooth surface a part of the emitted light 24 is radiated on flanks of the burr 18 as laterally reflected light 26b. Consequently, this can no longer be received and captured by the confocal point sensor 22 of the measuring means 20. Only a part of the vertically reflected light 26a is returned into the point sensor 22.

Together with a non-depicted control means or a computer unit the measuring means 20 is in each case designed, depending on a ratio between the emitted light 24 and the proportion of the reflected light 26 which is returned into the point sensor 22, to make an statement as to the degree, in particular the number and/or size, of burrs 18 on the groove structure 12 of the workpiece 10. Depending on the measurement result a signal indicating, for example, a necessary change of the machining tool in the previous machining step of introducing the groove structure 12, can then be issued or such a change is brought about automatically.

Subsequent to the measurement a surface coating of the surface of the workpiece 10 with the groove structure 12 can take place. In particular, this can be implemented by spraying on melted metal particles using sufficiently known spraying methods.

1. Method for machining a workpiece with a surface, in particular in a bore, into which a groove structure with grooves and interposed ribs is introduced, wherein undesirable burrs can develop on the groove structure,
characterized in that
for testing and determining a formation of burrs a measuring means is provided which emits a light to the surface of the groove structure and receives light reflected from the surface, wherein a degree of the burr formation is determined depending on the reflected light.

2. Method according to claim 1,
characterized in that
by means of the measuring means the determination of the burr formation is carried out simultaneously or immediately after the introduction of the groove structure.

3. Method according to claim 1,
characterized in that
the light is chromatic.

4. Method according to claim 1,
characterized in that
the measuring means has at least one confocal point sensor which emits and receives the light.

5. Method according to claim 1,
characterized in that
a reduction of a ratio between reflected light and emitted light is considered as a degree of an increase in the burr formation.

6. Method according to claim 1,
characterized in that
the groove structure is introduced with a material removing tool, in particular a cutting head or a rotary chisel.

7. Method according to claim 6,
characterized in that
on reaching a predetermined value for the reflected light the material removing tool is readjusted and/or exchanged.

8. Method according to claim 1,
characterized in that
after the introduction and testing of the groove structure a coating is applied thereto.

9. Arrangement for machining a workpiece, in particular pursuant to a method according to claim 1, with a material removal device for introducing a groove structure with grooves and interposed ribs into a surface of the workpiece,
characterized in that
for testing and determining a formation of burrs on the groove structure a measuring means is provided which is designed to emit a light to the surface of the groove structure and receive light reflected from the surface, wherein a degree of the burr formation can be determined depending on the reflected light.

10. Arrangement according to claim 9,
characterized in that
the measuring means is arranged on the material removal device.

11. Arrangement according to claim 9,
characterized in that
the groove structure is introduced into the workpiece with at least one material removing tool and
in that a display is provided which, depending on a measurement result of the measuring means, displays when the at least one material removing tool is to be changed.

12. Arrangement according to claim 1,
characterized in that
the measuring means has at least one confocal point sensor which emits and receives the light.
